(19) United States
(12) Patent Application Publication
(10) Pub. No.: US 2024/0373540 A1
(43) Pub. Date: Nov. 7, 2024

(54) PLASMA JET GENERATOR AND GENERATION METHOD

(71) Applicants: STATE GRID JIANGSU ELECTRIC POWER CO., LTD. CHANGZHOU BRANCH, Changzhou (CN); STATE GRID JIANGSU ELECTRIC POWER CO., LTD., Nanjing (CN)

(72) Inventors: Jiazhen DUAN, Changzhou (CN); Ruxin SHI, Changzhou (CN); Hongtao LIU, Changzhou (CN); Jie CHEN, Changzhou (CN); Zhaoyang CHEN, Changzhou (CN); Yicong HE, Changzhou (CN); Xianming REN, Changzhou (CN)

(21) Appl. No.: 18/778,404

(22) Filed: Jul. 19, 2024

Related U.S. Application Data
(63) Continuation of application No. PCT/CN2024/082331, filed on Mar. 19, 2024.

(30) Foreign Application Priority Data
Apr. 12, 2023 (CN) 202310383220.6

(51) Int. Cl. H05H 1/34; H05H 1/42

(52) U.S. Cl. CPC H05H 1/3478; H05H 1/3405; H05H 1/42

(57) ABSTRACT

A plasma jet generator includes a base, a jet gun cavity, a blocking insulating medium, a porous air intake plate, a high-voltage port, a high-voltage electrode housing, and a jet gun tip. The base is detachably connected to a first end of the jet gun cavity. The blocking insulating medium is inserted in the base. The porous air intake plate is detachably mounted in the blocking insulating medium. The high-voltage electrode housing is detachably mounted in the porous air intake plate. The high-voltage port is disposed in the high-voltage electrode housing. The jet gun tip is detachably mounted at a second end of the jet gun cavity.

### CROSS-REFERENCE TO RELATED APPLICATIONS

This is a continuation of International Patent Application No. PCT/CN2024/082331, filed on Mar. 19, 2024, which claims priority to Chinese Patent Application No. 202310383220.6 filed on Apr. 12, 2023, the disclosures of which are incorporated herein by reference in their entireties.

### TECHNICAL FIELD

The present application relates to the technical field of plasma jet generators, for example, a plasma jet generator and a plasma jet generation method.

### BACKGROUND

Plasma is the fourth state of matter that follows solid, liquid, and gas. A plasma state system is rich in high-energy active particles such as high-energy electrons, ions, excited-state atoms, and free radicals. It has received attention from experts and engineers in fields such as new energy preparation, environmental protection, material processing, and aerospace. With the continuous expansion of the field of surface modification of plasma materials, the application prospects of plasma jets are also expanding. Plasma jets are now widely used in fields such as medical instruments, biomedicine and material surface treatment.

In the field of material surface treatment, repairing surface cracks and fractures of cables is one of the current research directions. The aging and damage of cable sheaths and accessories directly affect the service life of cables and may even cause electrical leakage and power outages, seriously affecting the safe and stable operation of a power system. The cable sheath is the first line of defense in protecting the cable, and its integrity is of great significance to the service life of the cable. Cables are prone to mechanical damage during installation and operation. According to statistics, more than 70% of faults in 110 kV and above cable systems of the State Grid Corporation of China are caused by external damage. Cable accessories play a crucial role in the connection and transition of transmission lines. According to statistics, among the faults that occur in 110 KV and above cable systems, excluding the faults caused by external damage, the faults caused by cable accessories account for as high as 85.5%. Therefore, the health status of cable sheaths and accessories is an important influencing factor for the safe and stable operation of cable systems.

When inspecting and repairing cables outdoors, after multiple modifications of low-temperature plasma jets, a large amount of deposits adheres to the surface of the pipe wall. Since the traditional jet gun is integral in structure, it needs to be replaced as a whole when replacement is necessary, which is cumbersome and costly, thereby making outdoor operations extremely inconvenient.

### SUMMARY

The present application provides a plasma jet generator. The plasma jet generator includes a base, a jet gun cavity, a blocking insulating medium, a porous air intake plate, a high-voltage port, a high-voltage electrode housing, and a jet gun tip. The base is detachably connected to a first end of the jet gun cavity. The blocking insulating medium is inserted in the base. The porous air intake plate is detachably mounted in the blocking insulating medium. The high-voltage electrode housing is detachably mounted in the porous air intake plate. The high-voltage port is disposed in the high-voltage electrode housing. The jet gun tip is detachably mounted at a second end of the jet gun cavity. The blocking insulating medium, the porous air intake plate, the high-voltage port, and the high-voltage electrode housing are located in the jet gun cavity.

According to another aspect of the present application, a plasma jet generation method is provided. The method includes causing air to enter through the base, pass through the porous air intake plate, and then enter the blocking insulating medium; connecting a high-voltage wire from the base to the high-voltage port and causing the high-voltage wire to contact the high-voltage electrode housing; under the action of a high voltage, causing ionization to occur on the surface of the jet gun cavity and the surface of the jet gun tip, causing the air that has entered to become charged, and causing a plasma jet to be formed; and causing the plasma jet to be ejected from the jet gun tip.

### BRIEF DESCRIPTION OF DRAWINGS

FIG. 1 illustrates the overall structure of a plasma jet generator according to embodiments of the present application.

FIG. 2 is a section view of the plasma jet generator according to embodiments of the present application.

FIG. 3 illustrates the structure of a base according to embodiments of the present application.

FIG. 4 illustrates another structure of the base according to embodiments of the present application.

FIG. 5 illustrates the structure of a jet gun cavity according to embodiments of the present application.

FIG. 6 is a section view of the jet gun cavity according to embodiments of the present application.

FIG. 7 illustrates the structure of a blocking insulating medium according to embodiments of the present application.

FIG. 8 illustrates the structure of a porous air intake plate according to embodiments of the present application.

FIG. 9 is a perspective view of the porous air intake plate according to embodiments of the present application.

FIG. 10 illustrates the structure of a high-voltage port according to embodiments of the present application.

FIG. 11 illustrates the structure of a high-voltage electrode housing according to embodiments of the present application.

FIG. 12 illustrates the structure of a jet gun tip according to embodiments of the present application.

FIG. 13 illustrates the structure of a handle rod according to embodiments of the present application.

### REFERENCE LIST

1. base, 101. air passage hole, 102. high-voltage wire hole, 103. first outer thread, 104. first receiving cavity, 2. jet gun cavity, 201. first internal thread, 202. second internal thread, 203. boss, 204. recess, 3. blocking insulating medium, 301. third internal thread, 4. porous air intake plate, 401. internal threaded hole, 402. helical hole, 403. second outer thread, 5. high-voltage port, 501. tubular portion, 502. high-voltage electrode housing contact portion, 6. high-voltage electrode housing, 601. third outer thread, 7. jet gun tip, 701. fourth outer thread, 8. handle rod, 801. ring portion, 802. cylindrical portion

### DETAILED DESCRIPTION

Hereinafter technical solutions in embodiments of the present application are described in conjunction with the drawings in the embodiments of the present application.

Terms used herein are for the purpose of describing specific embodiments only and not intended to limit the exemplary embodiments according to the present application. As used herein, unless otherwise specified in the context, the singular is intended to include the plural as well; furthermore, it is to be understood that when the terms “comprising” and/or “including” are used in this specification, the terms indicate that the existing features, steps, operations, devices, components, and/or combinations thereof.

Unless otherwise specified, the relative arrangement, numerical expressions, and values of the components and steps described in these embodiments do not limit the scope of the present invention. Meanwhile, for ease of description, the dimensions of multiple parts shown in the drawings are not necessarily drawn to scale. In all examples shown and discussed here, any values should be interpreted as exemplary rather than limiting. Therefore, other examples of example embodiments may have different values. Similar reference numerals and letters indicate similar items in the subsequent drawings, and therefore, once a particular item is defined in one drawing, similar reference numerals and letters needs no more definition and explanation in subsequent drawings.

In the description of the present application, orientations or position relations indicated by terms such as “front”, “rear”, “upper”, “lower”, left”, “right”, “horizontal”, “vertical”, “top”, and “bottom” are based on orientations or position relations shown in the drawings. These orientations or position relations are intended to facilitate and simplify description of the present application. Unless otherwise specified, these orientations or position relations are not intended to indicate or imply that a device or element referred to must have such orientations or must be structured or operated in such orientations. Thus, these orientations or position relations are not to be construed as limiting the present application. Orientation terms “inner” and “outer” refer to the inside and outside of the contour of each component.

For ease of description, spatial terms such as “above”, “on”, “on the upper surface of”, and “upper” can be used here to describe the spatial relationships between a device or feature and other devices or features in the drawings. Spatial terms are intended to encompass different orientations in use or operation beyond the orientations of the devices as shown in the drawings. For example, when a device in a drawing is inverted, the device described as “above other devices or structures” or “on other devices or structures” is later be described as “below other devices or structures” or “under other devices or structures”. Therefore, the example term “on” may include “on” and “under”. The device can also be positioned in other manners (rotated 90 degrees or in other orientations), and corresponding explanations for the spatial descriptions used here are provided accordingly.

Moreover, the use of words such as “first” and “second” to define components is for the purpose of distinguishing between corresponding components. Unless otherwise specified, these words do not have any special meaning and should not be construed as limiting the scope of the present application.

The present application solves the problem in the related art that the replacement of a jet gun with an integral structure is cumbersome and costly. The present application provides a plasma jet generator. In the plasma jet generator, the jet gun cavity, high-voltage electrode housing, and jet gun tip are each detachable through a thread. In the case of excessive deposition, detachment and replacement are easy, involving easy operation and low costs without replacement of the whole machine. The present application also provides a plasma jet generation method based on the plasma jet generator.

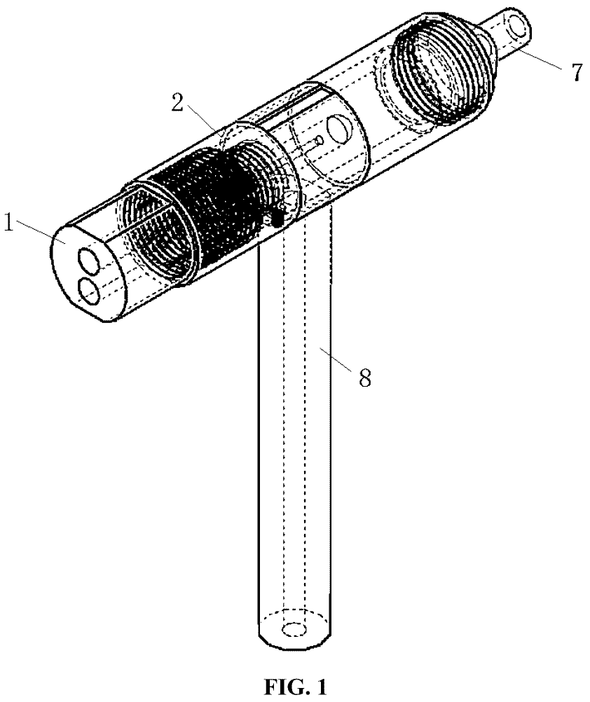

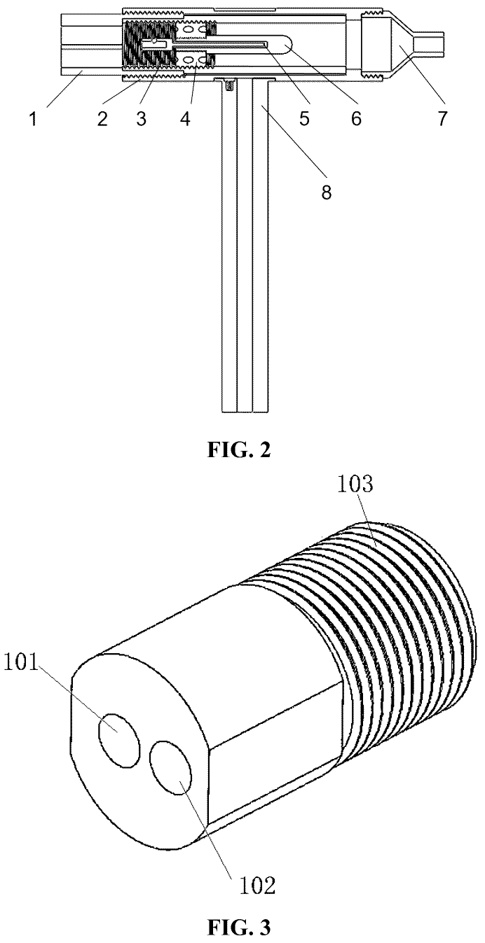

As shown in FIG. 1 and FIG. 2, a plasma jet generator includes a base 1, a jet gun cavity 2, a blocking insulating medium 3, a porous air intake plate 4, a high-voltage port 5, a high-voltage electrode housing 6, and a jet gun tip 7. The base 1 is detachably connected to a first end of the jet gun cavity 2. The outer diameter of the blocking insulating medium 3 is the same as the inner diameter of the base 1 so that the blocking insulating medium 3 can be secured when inserted into the base 1. The porous air intake plate 4 is detachably mounted in the blocking insulating medium 3. The high-voltage electrode housing (6) is detachably mounted in the porous air intake plate (4), facilitating the replacement of the high-voltage electrode housing (6) corroded due to deposition of metal surface films. The distance between the high-voltage electrode housing (6) and the ground electrode of the jet gun cavity (2) can be easily adjusted by the rotation of the porous air intake plate (4) to achieve optimal discharge performance. The high-voltage electrode housing 6 is located at the center of the jet gun cavity 2, ensuring power generation uniformity. The high-voltage port 5 is disposed in the high-voltage electrode housing 6. The high-voltage electrode housing 6 is connected to an excitation power supply by the high-voltage port 5. The jet gun tip 7 is detachably mounted on a second end of the jet gun cavity 2. Moreover, the blocking insulating medium 3, the porous air intake plate 4, the high-voltage port 5, and the high-voltage electrode housing 6 are all mounted in the jet gun cavity 2.

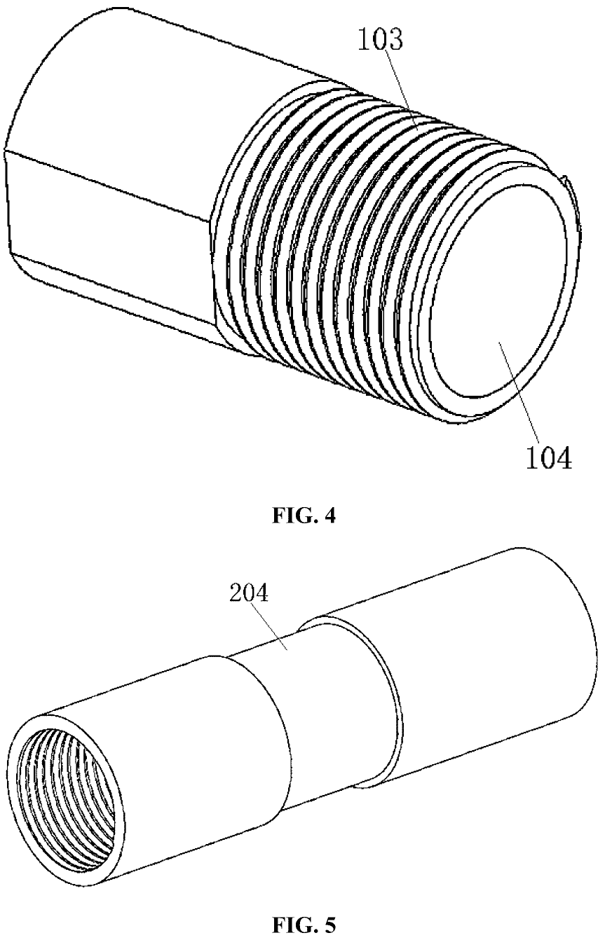

In some embodiments, as shown in FIG. 3 and FIG. 4, a first outer thread 103 for threaded connection to the jet gun cavity 2 is formed on the outer side of a first end of the base 1, and a first receiving cavity 104 for receiving the blocking insulating medium 3 is disposed inside the first end of the base 1. The first receiving cavity 104 has a diameter of 17 mm and a depth of 20 mm. An air passage hole 101 for an air tube to pass through and a high-voltage wire hole 102 for a high-voltage wire to pass through are formed at a second end of the base 1. To facilitate screwing of the base 1, the base 1 has two planes that are cut on opposite sides of the outer surface of the base 1 provided with the air passage hole 101 and the high-voltage wire hole 102. The part of the base 1 having the first outer thread 103 has a diameter of 20 mm and a length of 20 mm. The other part of the base 1 without the first outer thread 103 has a radius of 11 mm and a length of 20 mm. The air passage hole 101 has a diameter of 6 mm. The high-voltage wire hole 102 has a diameter of 6 mm.

In some embodiments, as shown in FIG. 5 and FIG. 6, the jet gun cavity 2 is a hollow structure, a first internal thread 201 for threaded connection to the base 1 is formed at one end of the jet gun cavity 2, and a second internal thread 202 for threaded connection to the jet gun tip 7 is formed at the other end of the jet gun cavity 2. The first internal thread 201 has a length of 20 mm. The second internal thread 202 has a length of 8 mm. A boss 203 for limiting the position of one end of the blocking insulating medium 3 is disposed in the jet gun cavity 2. The boss 203 is disposed at the end of the jet gun cavity 2 facing the second internal thread 202. The boss 203 is 7 mm away from the end of the jet gun cavity 2 facing the second internal thread 202. The boss 203 has a diameter of 16 mm and a length of 8 mm. A groove 204 is disposed on the outer side of the jet gun cavity 2. The groove 204 has a diameter of 22 mm and a length of 20 mm. The distance between the front end of the high-voltage electrode housing 6 and the boss 203 of the jet gun cavity 2 is about 17 mm, satisfying the jet requirements. The jet gun cavity 2 has a diameter of 24 mm and a length of 85 mm. The jet gun cavity 2 is a hollow structure whose center is provided with a circular hole having a diameter of 20 mm. The jet gun cavity 2 is made of stainless steel and thus has a good conductive performance and mechanical strength and a long service life.

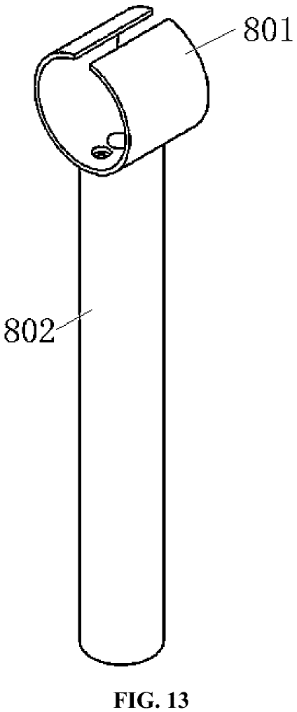

In some embodiments, as shown in FIG. 13, a handle rod 8 is mounted around the groove 204. The handle rod 8 includes a ring portion 801 (having an outer diameter of 24 mm and an inner diameter of 22 mm) and a cylindrical portion 802 (having a diameter of 15 mm and a height of 110 mm). A notch for easy connection between the ring portion 801 and the groove 204 is disposed on the ring portion 801 along an axial direction perpendicular to the circumference of the ring portion 801. The ring portion 801 is made of conductive material. The cylindrical portion 802 is made of insulating material. A ground wire hole (having a diameter of 5 mm) and a ground wire inner core securing threaded hole are formed in the ring portion 801. The ground wire inner core securing threaded hole is configured to secure an extended ground wire inner core to make the ring portion 801 grounded. Optionally, the ground wire connects the cylindrical portion 802 and the ring portion 801, and the ground wire inner core is secured to the surface of the ring portion 801 by a screw, greatly improving security during use.

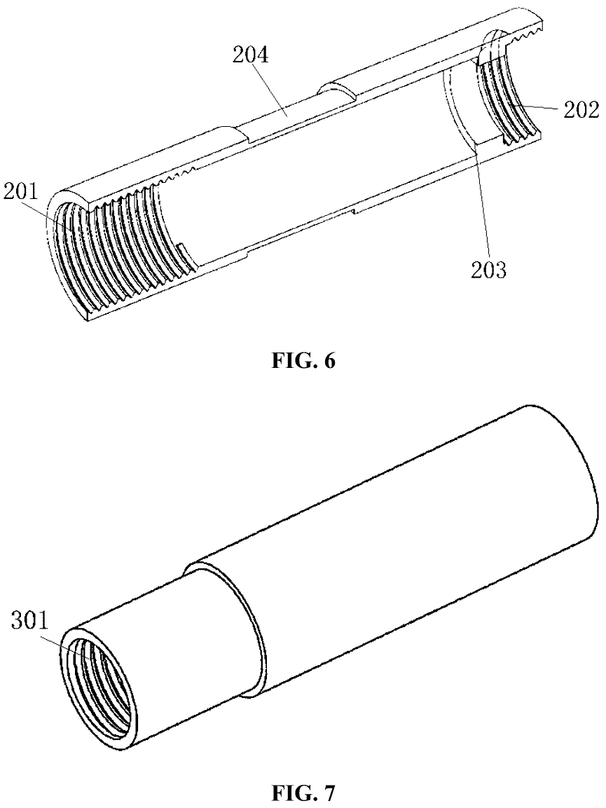

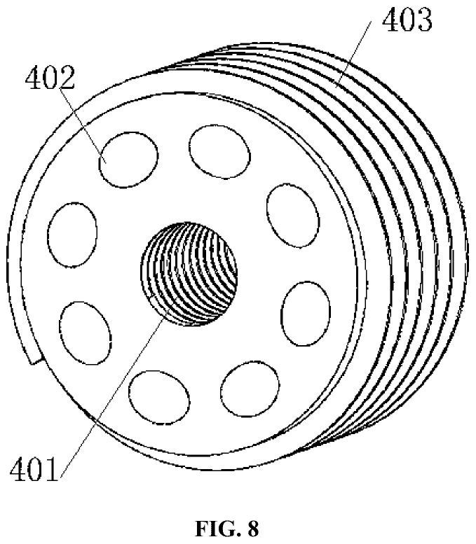

In some embodiments, as shown in FIG. 7, a stepped structure is formed on the outer side of the blocking insulating medium 3. The part (having a diameter of 17 mm and a length of 20 mm) of the blocking insulating medium 3 having a small diameter is configured to be inserted into the based 1. The other part of the blocking insulating medium 3 has a diameter of 19 mm and a length of 53 mm. The inner aperture of the blocking insulating medium 3 has a diameter of 14 mm. A third internal thread 301 for mounting of the porous air intake plate 4 is formed at the end (having a diameter of 17 mm) of the blocking insulating medium 3. The third internal thread 301 has a length of 30 mm so that the position of the porous air intake plate 4 can be adjusted by the cooperation of the blocking insulating medium 3 and the porous air intake plate 4 to achieve an optimal modification effect. The blocking insulating medium 3 is made of polytetrafluoroethylene.

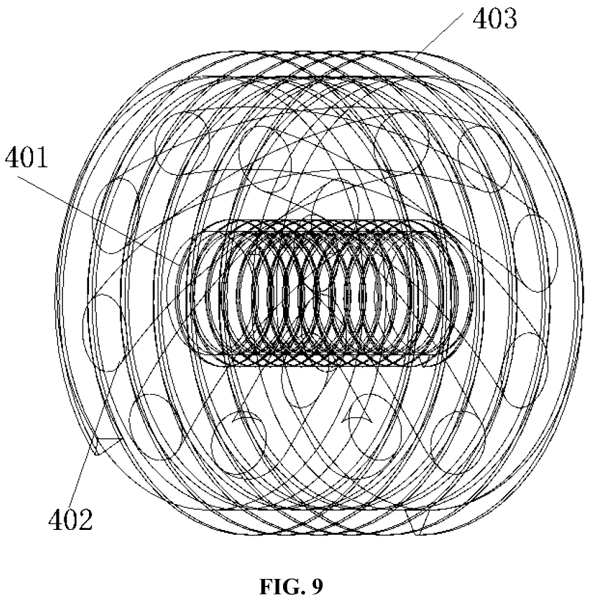

In some embodiments, as shown in FIG. 8 and FIG. 9, the porous air intake plate 4 has a diameter of 14 mm and a length of 10 mm. A second outer thread 403 for threaded connection to the blocking insulating medium 3 is formed on the outer side of the porous air intake plate 4. An internal threaded hole 401 (having a diameter of 4 mm) for connection to the high-voltage electrode housing 6 is formed at the center of the porous air intake plate 4. The porous air intake plate 4 is provided with eight helical holes 402 having a diameter of 8 mm. The included angle between each helical hole 402 and the vertical direction is 30 degrees so that air that has entered the plasma discharge space is fully mixed, avoiding airflow non-uniformity caused by air hole splitting. The length of the third internal thread 301 is greater than the length of the second outer thread 403; therefore, an adjustment of the second outer thread 403 can adjust the position of the porous air intake plate 4 in the blocking insulating medium 3, thereby making the high-voltage electrode housing 6 appropriately away from the boss 203 of the jet gun cavity 2.

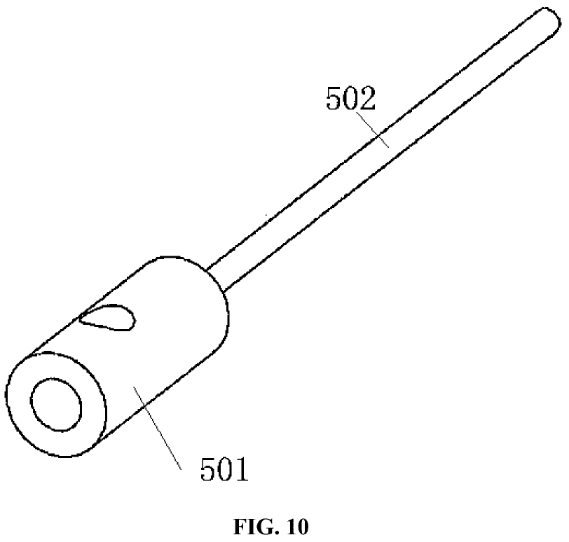

In some embodiments, as shown in FIG. 10, the high-voltage port 5 includes a tubular portion 501 and a high-voltage electrode housing contact portion 502. The tubular portion 501 has a diameter of 4 mm and a length of 10 mm. The inner aperture of the tubular portion 501 has a diameter of 2 mm and a length of 8 mm. The tubular portion 501 has a hole (having a diameter of 2 mm) for mounting of a screw. This hole is configured to cooperate with the screw to secure the high-voltage wire, preventing the high-voltage wire from slipping out of the inner aperture of the tubular portion 501. The high-voltage electrode housing contact portion 502 has a diameter of 1 mm and a length of 30 mm. The high-voltage electrode housing contact portion 502 is configured to contact the high-voltage electrode housing 6. Optionally, the high-voltage wire passes through the high-voltage wire hole 102 of the base 1, the tubular portion 501 is inserted in the insulation layer of the high-voltage wire, and each wire (copper wire) in the insulation layer is secured by a screw.

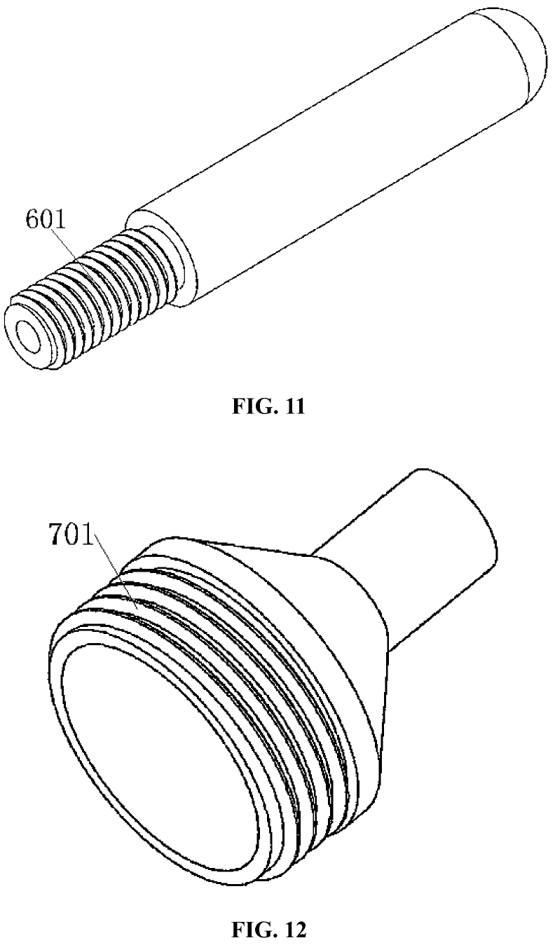

In some embodiments, as shown in FIG. 11, a third outer thread 601 for threaded connection to the porous air intake plate 4 is formed at one end of the high-voltage electrode housing 6. The third outer thread 601 has a diameter of 4 mm and a length of 10 mm. The part of the high-voltage electrode housing 6 with no outer thread has a diameter of 6 mm and a length of 28 mm. A hole for receiving the high-voltage electrode housing contact portion 502 is formed inside the end of the high-voltage electrode housing 6 having the third outer thread 601. This hole has a diameter of 2 mm and a depth of 20 mm, ensuring that the high-voltage electrode (wire/copper wire) is located at the center of the cavity.

In some embodiments, as shown in FIG. 12, the overall length of the jet gun tip 7 is 27 mm, the center of the jet gun tip 7 is a tapered structure, the two ends of the jet gun tip 7 are hollow cylinders, a fourth outer thread 701 for threaded connection to the jet gun cavity 2 is formed on the outer side of the hollow cylinder having a larger diameter, the hollow cylinder having a larger diameter has an outer diameter of 20 mm and an inner diameter of 18 mm, the hollow cylinder having a larger diameter has a M20×1.5 outer thread with a length of 6 mm, and the hollow cylinder having a smaller diameter has an outer diameter of 8 mm, an inner diameter of 5 mm, and a length of 10 mm. This structure of the jet gun tip 7 enables a more concentrated plasma jet plume and a more noticeable material processing effect.

The jet gun cavity, high-voltage electrode housing, and jet gun tip of the plasma jet generator of the present application are all detachable via threads. In the case of excessive deposits, they can be easily disassembled and replaced, simplifying the operation and avoiding the need for complete replacement, thus reducing costs.

The working principle of the plasma jet generator of the present application is as follows.

Air enters through the air passage hole 101 of the base 1. With the porous air intake plate with helical holes, the air passes through the porous air intake plate 4 and then enters the blocking insulating medium 3, ensuring thorough mixing of the air that has entered the plasma discharge space, avoiding airflow non-uniformity caused by air hole splitting, ensuring the uniformity of the air that has entered the discharge space, avoiding turbulence, maintaining discharge stability, and preventing accidents. The high-voltage wire enters through the high-voltage wire hole 102 of the base 1, is connected to the high-voltage port 5, and contacts the high-voltage electrode housing 6 to charge the high-voltage electrode housing 6 with a high voltage. The blocking insulating medium 3 is made of polytetrafluoroethylene, avoiding arcing. The base 1 is connected to the jet gun cavity 2. The ground electrode passes through the handle rod 8 and is connected to the ring portion 801. The ground wire inner core is secured by a screw on the side. The cylindrical portion 802 is made of insulating material, and the ring portion 801 is made of metal, making the outer wall serve as the ground electrode, satisfying the requirements of low-temperature plasma jetting, and ensuring the discharge stability.

A plasma jet generation method includes that air is input via the base 1, passes through the porous air intake plate 4, and then enters the blocking insulating medium 3; a high voltage on the high-voltage electrode housing 6 is generated by connecting a high-voltage wire from the base 1 to the high-voltage port 5 and contacting the high-voltage wire with the high-voltage electrode housing 6; under the action of a high voltage, ionization generated on the surface of the jet gun cavity 2 and the surface of the jet gun tip 7, causing the input air to become charged; with the cooperation of a field strength, an electron moves towards the high-voltage electrode housing 6; during the movement of the electrode, ionization occurs so that a new electron is generated; under the action of a field strength, the new electron and the initial electron continue moving towards the high-voltage electrode housing 6, during the movement of the new electron and the initial electron, new ionization occurs; this process is repeated so that electron avalanche occurs, and a large quantity of positive and negative charges are generated; and under the combined action of the electric field and the charged air, positive charges move towards the jet gun cavity 2 and the jet gun tip 7 and are output through the jet gun tip 7, thus forming a plasma jet.

What is claimed is:

1. A plasma jet generator, comprising:
a base, a jet gun cavity, a blocking insulating medium, a porous air intake plate, a high-voltage port, a high-voltage electrode housing, and a jet gun tip;
wherein the base is detachably connected to a first end of the jet gun cavity, the blocking insulating medium is inserted in the base, the porous air intake plate is detachably mounted in the blocking insulating medium, the high-voltage electrode housing is detachably mounted in the porous air intake plate, the high-voltage port is disposed in the high-voltage electrode housing, and the jet gun tip is detachably mounted at a second end of the jet gun cavity; and
the blocking insulating medium, the porous air intake plate, the high-voltage port, and the high-voltage electrode housing are located in the jet gun cavity.

2. The plasma jet generator of claim 1, wherein
a first outer thread for threaded connection to the jet gun cavity is formed on an outer side of a first end of the base;
a first receiving cavity for receiving the blocking insulating medium is disposed inside the first end of the base; and
an air passage hole for an air tube to pass through and a high-voltage wire hole for a high-voltage wire to pass through are formed at a second end of the base.

3. The plasma jet generator of claim 1, wherein the jet gun cavity is a hollow structure;
a first internal thread for threaded connection to the base is formed at a first end of the jet gun cavity;
a second internal thread for threaded connection to the jet gun tip is formed at a second end of the jet gun cavity;
a boss for limiting a position of one end of the blocking insulating medium is disposed in the jet gun cavity; and
a groove is disposed on an outer side of the jet gun cavity.

4. The plasma jet generator of claim 3, wherein a handle rod is mounted around the groove, the handle rod comprises a ring portion and a cylindrical portion;
a notch for easy connection to the groove is disposed on the ring portion along an axial direction perpendicular to a circumference of the ring portion;
the ring portion is made of conductive material, the cylindrical portion is made of insulating material; and
a ground wire hole and a ground wire inner core securing threaded hole are formed in the ring portion.

5. The plasma jet generator of claim 1, wherein a stepped structure is formed on an outer side of the blocking insulating medium and configured to be inserted into the base;
a third internal thread for mounting of the porous air intake plate is formed at one end of the blocking insulating medium; and
the blocking insulating medium is made of polytetrafluoroethylene.

6. The plasma jet generator of claim 1, wherein a second outer thread for threaded connection to the blocking insulating medium is formed on an outer side of the porous air intake plate;
an internal threaded hole for connection to the high-voltage electrode housing is formed at a center of the porous air intake plate; and
a plurality of helical holes are formed in the porous air intake plate.

7. The plasma jet generator of claim 1, wherein the high-voltage port comprises a tubular portion and a high-voltage electrode housing contact portion, and a hole for mounting of a screw is formed in the tubular portion.

8. The plasma jet generator of claim 7, wherein a third outer thread for threaded connection to an internal threaded hole formed at a center of the porous air intake plate is formed at one end of the high-voltage electrode housing; and
a hole for receiving the high-voltage electrode housing contact portion is formed inside the high-voltage electrode housing.

9. The plasma jet generator of claim 1, wherein a center of the jet gun tip is a cone, two ends of the jet gun tip are hollow cylinders; and
a fourth outer thread for threaded connection to the jet gun cavity is formed on an outer side of a hollow cylinder having a larger diameter among the hollow cylinders.

10. A plasma jet generation method, applied to a plasma jet generator, wherein the plasma jet generator comprising: a base, a jet gun cavity, a blocking insulating medium, a porous air intake plate, a high-voltage port, a high-voltage electrode housing, and a jet gun tip;
the base is detachably connected to a first end of the jet gun cavity, the blocking insulating medium is inserted in the base, the porous air intake plate is detachably mounted in the blocking insulating medium, the high-voltage electrode housing is detachably mounted in the porous air intake plate, the high-voltage port is disposed in the high-voltage electrode housing, and the jet gun tip is detachably mounted at a second end of the jet gun cavity; and
the blocking insulating medium, the porous air intake plate, the high-voltage port, and the high-voltage electrode housing are located in the jet gun cavity; and
wherein the plasma jet generation method comprising:
inputting air via the base to pass through the porous air intake plate, and then enter the blocking insulating medium;
generating a high voltage on the high-voltage electrode housing, by connecting a high-voltage wire from the base to the high-voltage port and contacting the high-voltage wire with the high-voltage electrode housing;
charging the input air, by generating ionization on a surface of the jet gun cavity and a surface of the jet gun tip under an action of the high voltage, to generate a plasma jet; and
outputting the plasma jet from the jet gun tip.

11. The plasma jet generation method of claim 10, wherein
a first outer thread for threaded connection to the jet gun cavity is formed on an outer side of a first end of the base;
a first receiving cavity for receiving the blocking insulating medium is disposed inside the first end of the base; and
an air passage hole for an air tube to pass through and a high-voltage wire hole for a high-voltage wire to pass through are formed at a second end of the base.

12. The plasma jet generation method of claim 10, wherein the jet gun cavity is a hollow structure;
a first internal thread for threaded connection to the base is formed at a first end of the jet gun cavity;
a second internal thread for threaded connection to the jet gun tip is formed at a second end of the jet gun cavity;
a boss for limiting a position of one end of the blocking insulating medium is disposed in the jet gun cavity; and
a groove is disposed on an outer side of the jet gun cavity.

13. The plasma jet generation method of claim 12, wherein a handle rod is mounted around the groove, the handle rod comprises a ring portion and a cylindrical portion;
a notch for easy connection to the groove is disposed on the ring portion along an axial direction perpendicular to a circumference of the ring portion;
the ring portion is made of conductive material, the cylindrical portion is made of insulating material; and
a ground wire hole and a ground wire inner core securing threaded hole are formed in the ring portion.

14. The plasma jet generation method of claim 10, wherein a stepped structure is formed on an outer side of the blocking insulating medium and configured to be inserted into the base;
a third internal thread for mounting of the porous air intake plate is formed at one end of the blocking insulating medium; and
the blocking insulating medium is made of polytetrafluoroethylene.

15. The plasma jet generation method of claim 10, wherein a second outer thread for threaded connection to the blocking insulating medium is formed on an outer side of the porous air intake plate;
an internal threaded hole for connection to the high-voltage electrode housing is formed at a center of the porous air intake plate; and
a plurality of helical holes are formed in the porous air intake plate.

16. The plasma jet generation method of claim 10, wherein the high-voltage port comprises a tubular portion and a high-voltage electrode housing contact portion, and a hole for mounting of a screw is formed in the tubular portion.

17. The plasma jet generation method of claim 16, wherein a third outer thread for threaded connection to an internal threaded hole formed at a center of the porous air intake plate is formed at one end of the high-voltage electrode housing; and
a hole for receiving the high-voltage electrode housing contact portion is formed inside the high-voltage electrode housing.

18. The plasma jet generation method of claim 10, wherein a center of the jet gun tip is a cone, two ends of the jet gun tip are hollow cylinders; and
a fourth outer thread for threaded connection to the jet gun cavity is formed on an outer side of a hollow cylinder having a larger diameter among the hollow cylinders.
